(19) United States
(12) Patent Application Publication
(10) Pub. No.: US 2024/0362470 A1
(43) Pub. Date: Oct. 31, 2024

(54) PANOPTIC PERCEPTION SYSTEM, METHOD THEREOF AND NON-TRANSITORY COMPUTER-READABLE MEDIA

(71) Applicant: MACRONIX INTERNATIONAL CO., LTD., Hsinchu (TW)

(72) Inventors: Yu-Chen LU, New Taipei City (TW); Sheng-Feng YU, Hsinchu City (TW); Wei-Cheng LIN, Changhua City (TW); Chi-Chih CHANG, Tainan City (TW); Pei-Shuo WANG, Taipei City (TW); Kuan-Cheng LIN, Taipei City (TW); Kai-Chiang WU, Hsinchu City (TW)

(21) Appl. No.: 18/479,893

(22) Filed: Oct. 3, 2023

Related U.S. Application Data
(60) Provisional application No. 63/462,261, filed on Apr. 27, 2023.

(51) Int. Cl. G06N 3/0495; G06N 3/08; G06V 20/58

(52) U.S. Cl. CPC G06N 3/0495; G06N 3/08; G06V 20/58

(57) ABSTRACT

The application provides a panoramic perception method, system and a non-transitory computer readable medium. The panoramic perception method comprises: performing a first pretraining on a plurality of weights of a training model using the source database; performing a second pretraining with data augmentation on the plurality of weights of the training model using the source database; performing a combined training on the plurality of weights of the training model using both the source database and the target database; performing a quantization-aware training on the plurality of weights of the training model using the source database and the target database; performing a post training quantization on the plurality of weights of the training model using the target database; and performing panoramic perception by the training model.

This application claims the benefit of U.S. provisional application Ser. No. 63/462,261, filed Apr. 27, 2023, the subject matter of which is incorporated herein by reference.

### TECHNICAL FIELD

The disclosure relates in general to a panoptic perception system, a method thereof and a non-transitory computer-readable media.

### BACKGROUND

A panoptic perception system is a critical component of autonomous vehicles, enabling them to comprehensively perceive and understand the surrounding environment. The panoptic perception system performs object detection and segmentation. Object detection is used to detect countable objects, such as but not limited to pedestrians, cars, motorcycles, bicycles, etc. Segmentation is employed to partition interesting regions, including but not limited to main lanes of drivable areas, alternative lanes in drivable areas, lane markings for oncoming lanes, and lane markings for same-direction lanes.

A panoptic perception system simultaneously addresses multiple visual tasks, including object detection, lane marking segmentation, drivable area segmentation, and generates a comprehensive understanding of road scenes. Efficiently handling and completing multiple tasks in the panoptic perception system is one of the industry's key areas of focus and effort.

### SUMMARY

According to one embodiment, provided is a panoramic perception method applied in a computer including a processing circuit and a storage device coupled to the processing circuit, the storage device including a plurality of hardware circuits for storing a source database and a target database, the panoramic perception method comprising: performing a first pretraining on a plurality of weights of a training model using the source database; performing a second pretraining with data augmentation on the plurality of weights of the training model using the source database; performing a combined training on the plurality of weights of the training model using both the source database and the target database; performing a quantization-aware training on the plurality of weights of the training model using the source database and the target database; performing a post training quantization on the plurality of weights of the training model using the target database; and performing panoramic perception by the training model.

According to another embodiment, a panoramic perception system is provided. The panoramic perception system comprises: a processing circuit; and a storage device coupled to the processing circuit, the storage device including a plurality of hardware circuits for storing a source database and a target database. The processing circuit performs the following: performing a first pretraining on a plurality of weights of a training model using the source database; performing a second pretraining with data augmentation on the plurality of weights of the training model using the source database; performing a combined training on the plurality of weights of the training model using both the source database and the target database; performing a quantization-aware training on the plurality of weights of the training model using the source database and the target database; performing a post training quantization on the plurality of weights of the training model using the target database; and performing panoramic perception by the training model.

According to an alternative embodiment, a non-transitory computer-readable medium method is provided. When read by a computer, the computer executes the above panoramic perception method.

### BRIEF DESCRIPTION OF THE DRAWINGS

FIG. 1 depicts a flowchart of a panoramic perception method according to one embodiment of the present application.

FIG. 2 shows a detailed flowchart of the quantization-aware training process according to an exemplary embodiment of the present application.

FIG. 3 illustrates a schematic diagram of quantization (shifting) using the quantization scale according to an exemplary embodiment of the present application.

FIG. 4 illustrates a detailed flowchart of post-training quantization (PTQ) according to an exemplary embodiment of the present application.

FIG. 5 shows a functional block diagram of a panoramic perception system according to an embodiment of this application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

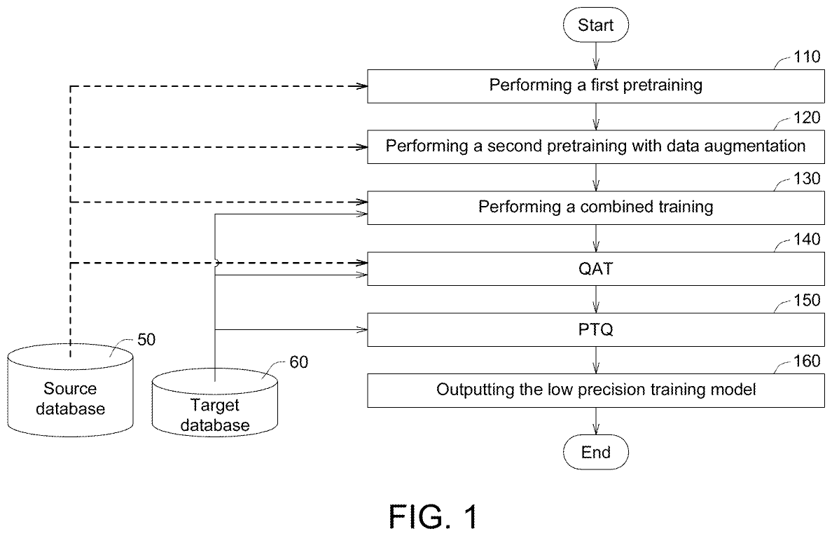

FIG. 1 depicts a flowchart of a panoramic perception method according to one embodiment of the present application. In step 110, an artificial intelligence model (e.g., but not limited to, a deep learning model) performs a first pre-training on a plurality of weights of a training model (e.g., but not limited to, a deep learning model) using data from a source database 50. The training model includes a plurality of operators and a plurality of weights. The operators of the training model are classified as high precision operators and low precision operators. In one embodiment of the application, the low precision operator is also referred as a first target operator while the high precision operator is also referred as a second target operator. Further, the precision of the operators, the weights and the inputs must be matched. That is, the low precision operators are limited to operate the low precision weights and the low precision inputs to generate low precision features (low precision outputs); and the high precision operators are limited to operate the high precision weights and the high precision inputs to generate high precision features (high precision outputs). In the following, “features” and “operator outputs” have the same or similar meanings. Initially, in step 110, the artificial intelligence model may randomly generate the weights of the training model. The artificial intelligence model utilizes data from the source database 50 to perform the first pre-training on the randomly generated weights of the training model. In this context, for example, the source database 50 is the “BDD-100K” dataset collected in the United States and Europe, which is a large and publicly available dataset. The “BDD-100K” dataset has a resolution of 1280×720 and includes 100,000 images. The data from the source database 50 is high-precision data. For example, the data from the source database 50 is 32-bit floating-point data. In the first pre-training, after the high precision data from the source database 50 and the high precision weights are input to the high precision target operators, the high precision target operators generate high-precision features (i.e. full precision features). In this case, for example, the high-precision features are 32-bit floating-point features. The first pre-training in step 110 can be regarded as high-precision training. The specific details of the first pre-training in step 110 are not particularly limited here.

In step 120, the artificial intelligence model performs a second pre-training on the weights of the training model using data from the source database 50, incorporating data augmentation techniques. In this case, data augmentation, such as but not limited to, mosaic data augmentation, Gaussian blur, contrast adjustment, saturation adjustment, hue adjustment, crop or rotation is employed. For example, multiple images (e.g., 4 images) are selected from the “BDD-100K” dataset to create a new composite image. Subsequently, the artificial intelligence model utilizes the new composite images generated through data augmentation techniques (such as mosaic techniques) to perform the second pre-training on the weights. Similarly, in the second pre-training, after the high precision data (the new composite images) and the high precision weights are input to the high precision target operators, the high precision target operators generate high-precision features. Therefore, the training in step 120 can be regarded as high-precision training. The specific details of the second pre-training in step 120 are not particularly limited here.

In step 130, the artificial intelligence model performs a combined training on the weights of the training model using data from both the source database 50 and the target database 60. In this case, for example, the target database 60 is the “iVS” dataset collected locally in Taiwan. The “iVS” dataset is a smaller, private dataset. It has a resolution of 1920×1080 and consists of 49 videos, each lasting 75 seconds, resulting in a total of 49*75=3675 images in the “iVS” dataset. The data in the target database 60 is high-precision data. For example, the data in the target database 60 is 32-bit floating-point data. In the combined training, after the high precision data (from the source database 50) and the high precision weights are input to the high precision target operators, the high precision target operators generate high-precision features; and after the low precision data (from the target database 60) and the low precision weights are input to the low precision target operators, the low precision target operators generate low-precision features. The specific details of the combined training in step 130 are not particularly limited here.

In step 140, the artificial intelligence model performs quantization-aware training (QAT) on the weights of the training model using data from both the source database 50 and the target database 60. In this embodiment, quantization-aware training is conducted to optimize the weights of the target operator for suitable use in quantized operations. Quantization-aware training is a deep learning model training technique aimed at simulating the behavior of the model after quantization and taking these behaviors into account during the training process. This ensures that the model maintains high performance even after quantization. Quantization involves converting floating-point parameters in the model to low-bit integers (such as 8-bit integers), which can reduce the size and execution speed of the model. Quantization-aware training is a technique that allows deep learning models to retain high performance post-quantization. During the training process, QAT simulates the effects of quantization and attempts to correct the errors introduced.

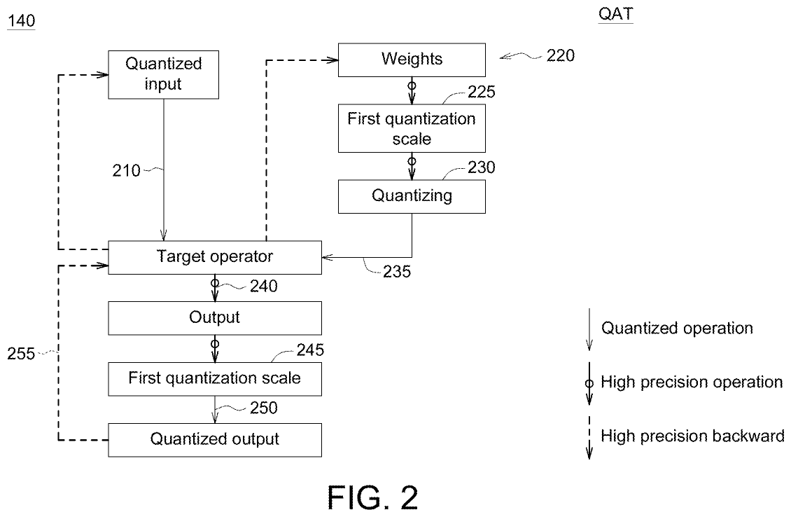

FIG. 2 shows a detailed flowchart of the quantization-aware training process according to an exemplary embodiment of the present application. FIG. 2 shows a training flow on each layer of the training model. A layer refers that the operators operate the inputs and the weights for generating outputs. As shown in FIG. 2, in step 210, a quantized input is input into the low precision target operator, wherein the quantized input is for example but not limited by, a quantized output from a previous layer or a quantized data from the source database 50.

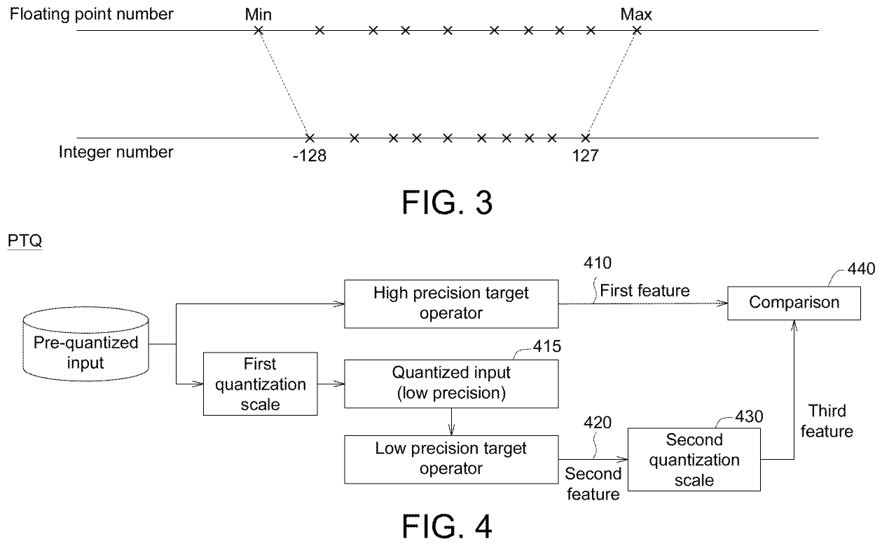

The weights (high-precision type) 220 are read from a layer of the training model, such as a convolutional layer or a fully connected layer. In step 225, the first quantization scale is determined. In step 230, the weights 220 are quantized using the first quantization scale, converting the high-precision weights into low-precision weights, and the quantized low-precision weights are used to perform operation. For example, the high-precision weights are scaling shifted to low-precision weights using the first quantization scale, as shown in FIG. 3. FIG. 3 illustrates a schematic diagram of quantization (scaling shifting) using the quantization scale according to an exemplary embodiment of the present application. During quantization (scaling shifting), the maximum value (as floating-point data) and minimum value (as floating-point data) of the data in the target operator's layer are determined, and also determining the appropriate quantization size and zero point. Additionally, a known formula is used to calculate the low-precision data (integer data) after quantization for any high-precision data (floating-point data). In this exemplary embodiment, the output is approximately to the quantized output after quantization.

In step 240, in the layer of the training model, the target operator operates the quantized input and quantized weights to generate an operation result and stores the operation result as a high-precision feature. In one embodiment of the application, there is a case that the operator is a MAC (multiply-and-accumulate) on several low-precision values. When the low-precision value has a value format of int8, then the low-precision value has a value range of −128˜127, but the operation result may be outside the value range (−128˜127). For example, when the operation is 127*127=16129, the operation result (16129) is outside of the value range (−128˜127). Thus, in the step 240, the operation result is stored as a high-precision feature. And the quantization scale is used to quantize the operation result into a low-precision feature.

In step 245, the high-precision output (high-precision feature) is quantized (scaling shifted) using the determined quantization scale, resulting in a quantized low-precision output. The weights can be iteratively trained using the process shown in FIG. 2 (i.e., iteratively generating/changing the weights).

Now, please refer back to FIG. 1. In step 150, the AI model performs post-training quantization (PTQ) on the training model. The advantage of PTQ is that PTQ does not require retraining the weights but instead uses a small portion of the dataset as a calibration set. Post-training quantization is a technique that quantizes a model after its training is completed. The purpose of post-training quantization is to reduce the model's size and inference time while trying to retain its accuracy as much as possible. Post-training quantization does not require retraining the model, making it simpler and faster.

FIG. 4 illustrates a detailed flowchart of post-training quantization (PTQ) according to an exemplary embodiment of the present application. As shown in FIG. 4, in step 410, the pre-quantized input data is fed into a high precision target operator (also referred as a second target operator) to obtain a first feature (high-precision feature), which serves as the reference for feature comparison. The high precision target operator (also referred as the second target operator) has higher precision than the low precision target operator (the first target operator). The high precision target operator is for example but not limited by, convolution, batch normalization, addition, multiplication and etc. In step 415, the pre-quantized input data (high-precision data) is input into the first quantization scale to obtain quantized input data (low-precision input data). In step 420, the quantized input data is fed into the low-precision target operator to obtain a second feature (low-precision feature). In step 430, a second quantization scale is determined. In step 440, the second feature (low-precision feature) is scaling shifted using the determined second quantization scale to obtain a third feature (high-precision feature), and the first feature is compared with the third feature. If the first feature matches the third feature, it indicates that the accuracy of the second quantization scale is sufficient. If the first feature does not match the third feature, it indicates that the accuracy of the second quantization scale is insufficient, and the second quantization scale is changed until the second quantization scale meets the requirements.

In step 160, the low-precision training model after training is output.

In one embodiment of this case, steps 140 and 150 in FIG. 1 are low-precision training.

In FIG. 1, steps 110 to 150 result in low-precision weights, wherein the weights are low precision (for example but not limited by, fixed-point number weights or integer weights).

In this embodiment of the application, QAT (Quantization-Aware Training) and PTQ (Post-Training Quantization) are performed to transfer the trained weights on the source dataset to the target dataset for deployment. Therefore, in this embodiment of the application, in step 130, a combined training is performed using the data from source database 50 and target database 60 to the low-precision weights trained in step 120. In step 140, QAT is used to train the weights. In step 150, PTQ is used to find appropriate quantization scales and zero points on the target dataset.

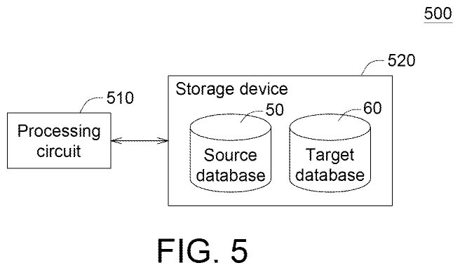

FIG. 5 shows a functional block diagram of a panoramic perception system according to an embodiment of this application. The panoramic perception system 500 in this embodiment includes a processing circuit 510 and a storage device 520. The processing circuit 510 is coupled to the storage device 520. The storage device 520 stores the source dataset 50 and the target dataset 60. The storage device 520 is for example but not limited by, a hard-disk, a solid-state disk (SSD), an optical disk or a USB disk. The processing circuit 510 can perform the panoramic perception method as shown in FIGS. 1 to 4. The processing circuit 510 may be implemented by, for example but not limited to, a central processing unit (CPU) or a graphics processing unit (GPU). The panoramic perception system 500 in this embodiment is implemented by a computer. The storage device 520 includes a plurality of hardware circuits for storing the source dataset 50 and the target dataset 60.

Another embodiment of this application discloses a non-transitory computer-readable medium. When the non-transitory computer-readable medium is read by a computer, the computer can execute the panoramic perception method as shown in FIGS. 1 to 4.

The present embodiment provides an efficient and effective panoramic perception method and system using the training model (such as, but not limited to, deep learning models) for object detection and semantic segmentation (including segmentation of lane lines and drivable areas) and panoptic segmentation used in self-driving vehicles. That is, in one embodiment of the application, the training models are used for panoramic perception.

In one embodiment of the application, QAT is performed on a mixed dataset (a combination of the target dataset and the source database), which not only adapts the quantized weights but also maintains the performance of detection and segmentation. Additionally, in one embodiment of the application, PTQ optimizes the quantization scales and zero points of the target dataset.

In the aforementioned embodiments, during the training phase, the proportion of the source dataset is gradually reduced, while the proportion of the target dataset is increased.

The training models in the aforementioned embodiments of the application can be applied to self-driving systems and factory defect recognition systems.

In the aforementioned embodiments of the application, the trained weights are low-precision; and the training model is low-precision. Therefore, when he training model performs computations using the low-precision target operators, lower power consumption is achieved, and computational speed can be increased.

To address the multitask problem of the panoramic perception system, one embodiment of the application discloses a panoramic perception system, a panoramic perception method, and a non-transitory computer-readable medium thereof specifically tailored for traffic scenes, solving the challenges of object detection and semantic segmentation. The panoramic perception system and method in one embodiment of the application can create efficient algorithms that accurately identify objects, segment lane lines and drivable areas, and maintain minimal computational costs, exhibiting outstanding performance in resource-constrained environments such as mobile devices, IoT (Internet of Things) devices, and embedded systems.

While this document may describe many specifics, these should not be construed as limitations on the scope of an application that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A panoramic perception method applied in a computer including a processing circuit and a storage device coupled to the processing circuit, the storage device including a plurality of hardware circuits for storing a source database and a target database, the panoramic perception method comprising:
performing a first pretraining on a plurality of weights of a training model using the source database;
performing a second pretraining with data augmentation on the plurality of weights of the training model using the source database;
performing a combined training on the plurality of weights of the training model using both the source database and the target database;
performing a quantization-aware training on the plurality of weights of the training model using the source database and the target database;
performing a post training quantization on the plurality of weights of the training model using the target database; and
performing panoramic perception by the training model.

2. The panoramic perception method according to claim 1, wherein the plurality of weights of the training model are randomly generated during initialization.

3. The panoramic perception method according to claim 1, wherein data in the source database and the target database are 32-bit floating-point data.

4. The panoramic perception method according to claim 1, wherein data augmentation includes mosaic data augmentation, Gaussian blur, contrast adjustment, saturation adjustment, hue adjustment, crop or rotation.

5. The panoramic perception method according to claim 1, wherein the quantization-aware training comprises:
inputting a quantized input into a first target operator, wherein the quantized input is a quantized output from a previous layer or a quantized data from the source database;
extracting a plurality of weights from a layer of the training model;
determining a first quantization scale;
quantizing the weights with the first quantization scale to generate a plurality of quantized weights;
performing operations on the quantized input and the quantized weights in the layer of the training model to obtain an output; and
quantizing the output with the first quantization scale to obtain a quantized output.

6. The panoramic perception method according to claim 1, wherein the post training quantization comprises:
inputting a pre-quantized input into a second target operator to obtain a first feature;
inputting the pre-quantized input into a first quantization scale to obtain a quantized input;
inputting the quantized input into a first target operator to obtain a second feature, wherein the second target operator has a precision higher than the first target operator;
determining a second quantization scale; and
scaling-shifting the second feature into a third feature using the second quantization scale and comparing the third feature with the first feature to determine whether to change the second quantization scale.

7. A panoramic perception system comprising:
a processing circuit; and
a storage device coupled to the processing circuit, the storage device including a plurality of hardware circuits for storing a source database and a target database;
wherein the processing circuit performs the following:
performing a first pretraining on a plurality of weights of a training model using the source database;
performing a second pretraining with data augmentation on the plurality of weights of the training model using the source database;
performing a combined training on the plurality of weights of the training model using both the source database and the target database;
performing a quantization-aware training on the plurality of weights of the training model using the source database and the target database;
performing a post training quantization on the plurality of weights of the training model using the target database; and
performing panoramic perception by the training model.

8. The panoramic perception system according to claim 7, wherein the processing circuit performs the following: randomly generating the plurality of weights of the training model during initialization.

9. The panoramic perception system according to claim 7, wherein data in the source database and the target database are 32-bit floating-point data.

10. The panoramic perception system according to claim 7, wherein data augmentation includes mosaic data augmentation, Gaussian blur, contrast adjustment, saturation adjustment, hue adjustment, crop or rotation.

11. The panoramic perception system according to claim 7, wherein in performing the quantization-aware training, the processing circuit performs the following:
inputting a quantized input into a first target operator, wherein the quantized input is a quantized output from a previous layer or a quantized data from the source database;
extracting a plurality of weights from a layer of the training model;
determining a first quantization scale;
quantizing the weights with the first quantization scale to generate a plurality of quantized weights;
performing operations on the quantized input and the quantized weights in the layer of the training model to obtain an output; and
quantizing the output with the first quantization scale to obtain a quantized output.

12. The panoramic perception system according to claim 7, wherein in performing the post training quantization, the processing circuit performs the following:
inputting a pre-quantized input into a second target operator to obtain a first feature;
inputting the pre-quantized input into a first quantization scale to obtain a quantized input;
inputting the quantized input into a first target operator to obtain a second feature, wherein the second target operator has a precision higher than the first target operator;
determining a second quantization scale; and
scaling-shifting the second feature into a third feature using the second quantization scale and comparing the third feature with the first feature to determine whether to change the second quantization scale.

13. A non-transitory computer-readable medium, when read by a computer, the computer executing the panoramic perception method according to claim 1.
